(19) United States
(12) Patent Application Publication
(10) Pub. No.: US 2025/0357656 A1
(43) Pub. Date: Nov. 20, 2025

(54) WINDSHIELD DEFROSTER ANTENNA

(71) Applicant: GM Global Technology Operations LLC, Detroit, MI (US)

(72) Inventors: Duane S. CARPER, Davison, MI (US); Gregg R. Kittinger, Oakland Township, MI (US); Nahel Eshaq, Rochester, MI (US); Hyok Jae Song, Oak Park, CA (US)

(21) Appl. No.: 18/668,719

(22) Filed: May 20, 2024

(51) Int. Cl. H01Q 1/12; B32B 17/10; H01Q 1/38

(52) U.S. Cl. CPC H01Q 1/1278; B32B 17/10174; H01Q 1/38

(57) ABSTRACT

A defrost and antenna system includes: a first glass pane including a first surface facing a passenger cabin of a vehicle and a second surface opposite the first surface; a second glass pane including a third surface facing the second surface and a fourth surface facing environment outside of the vehicle; and a keep out zone disposed between the second and third surfaces; and transparent electrically conductive material disposed between the second and third surfaces, the transparent electrically conductive material including: a defroster portion configured to generate heat when power is applied to the defroster portion; and an antenna radiator that is electrically isolated from the defroster portion by the keep out zone.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle windshields and more particularly to antennas and defrosters of windshields of vehicles.

Vehicles include one or more torque producing devices, such as an internal combustion engine and/or an electric motor. A passenger of a vehicle rides within a passenger cabin (or passenger compartment) of the vehicle.

Vehicles may include one or more different types of sensors that sense vehicle surroundings. One example of a sensor that senses vehicle surroundings is a camera configured to capture images of the vehicle surroundings. Examples of such cameras include forward-facing cameras, rear-facing cameras, and side facing cameras. Another example of a sensor that senses vehicle surroundings includes a radar sensor configured to capture information regarding vehicle surroundings. Other examples of sensors that sense vehicle surroundings include sonar sensors and light detection and ranging (LIDAR) sensors configured to capture information regarding vehicle surroundings.

### SUMMARY

In a feature, a defrost and antenna system includes: a first glass pane including a first surface facing a passenger cabin of a vehicle and a second surface opposite the first surface; a second glass pane including a third surface facing the second surface and a fourth surface facing environment outside of the vehicle; and a keep out zone disposed between the second and third surfaces; and transparent electrically conductive material disposed between the second and third surfaces, the transparent electrically conductive material including: a defroster portion configured to generate heat when power is applied to the defroster portion; and an antenna radiator that is electrically isolated from the defroster portion by the keep out zone.

In further features, the keep out zone includes at least one portion where the transparent electrically conductive material was removed.

In further features, discrete dots of the transparent electrically conductive material are disposed within the keep out zone.

In further features, the dots are each square.

In further features, a largest dimension of each of the dots is less than or equal to 5 millimeters.

In further features, a largest dimension of each of the dots is less than or equal to 3 millimeters.

In further features, the discrete dots are spaced apart uniformly.

In further features, a minimum distance between adjacent ones of the dots is less than or equal to 5 millimeters.

In further features, a minimum distance between adjacent ones of the dots is less than or equal to 3 millimeters.

In further features, the dots are each one of circular, rectangular, ovular, triangular, hexagonal, and octagonal.

In further features, a minimum distance between (a) a point on the antenna radiator and (b) a closest point of the defroster portion is less than or equal to 50 millimeters.

In further features, a minimum distance between (a) a point on the antenna radiator and (b) a closest point of the defroster portion is less than or equal to 30 millimeters.

In further features, the transparent electrically conductive material includes silver.

In further features, the keep out zone is formed via laser ablation of the transparent electrically conductive material.

In further features, the keep out zone extends around 3 sides of the antenna radiator.

In further features, the keep out zone extends around all sides of the antenna radiator.

In further features, the antenna radiator is one of a monopole antenna, a bipole antenna, and a slot antenna.

In further features, the transparent electrically conductive material has a sheet resistance of less than or equal to 1 ohm per square unit.

In further features, a polyvinyl butyral layer disposed between the second and third surfaces.

In a feature, a defrost and antenna system includes: a first glass pane including a first surface facing a passenger cabin of a vehicle and a second surface opposite the first surface; a second glass pane including a third surface facing the second surface and a fourth surface facing environment outside of the vehicle; and a keep out zone disposed between the second and third surfaces; transparent electrically conductive material disposed between the second and third surfaces, the transparent electrically conductive material including: a defroster portion configured to generate heat when power is applied to the defroster portion; an antenna radiator that is electrically isolated from the defroster portion by the keep out zone; discrete dots within the keep out zone; and a polyvinyl butyral layer disposed between the second and third surfaces.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of a vehicle including various external cameras and sensors;

FIG. 3 includes a cross-sectional view of a windshield and an antenna and a perspective view of the antenna; and

FIGS. 4 and 5 include perspective views including an antenna and a defroster.

In the drawings, reference numbers may be reused to identify similar and/or identical elements.

### DETAILED DESCRIPTION

Vehicles may include one or more different types of antennas. For example, a vehicle may include one or more cellular antennas, one or more WiFi antennas, one or more radar antennas, one or more lidar antennas, one or more Bluetooth antennas, etc. Antennas may be located in various locations within the vehicle.

Vehicles include one or more windshields, such as a front windshield and a rear windshield. While the present application will be discussed in terms of a windshield, the present application is applicable to fixed and moveable glass bodies of vehicles including windshields, roofs, etc. An electrically conductive and transparent defroster layer may be disposed between inner and outer layers of glass of a windshield and be used to defrost and/or defog the windshield.

The present application involves an antenna including a transmitter and/or receiver cut from the electrically conductive defroster layer. This saves space and decreases production complexity and cost.

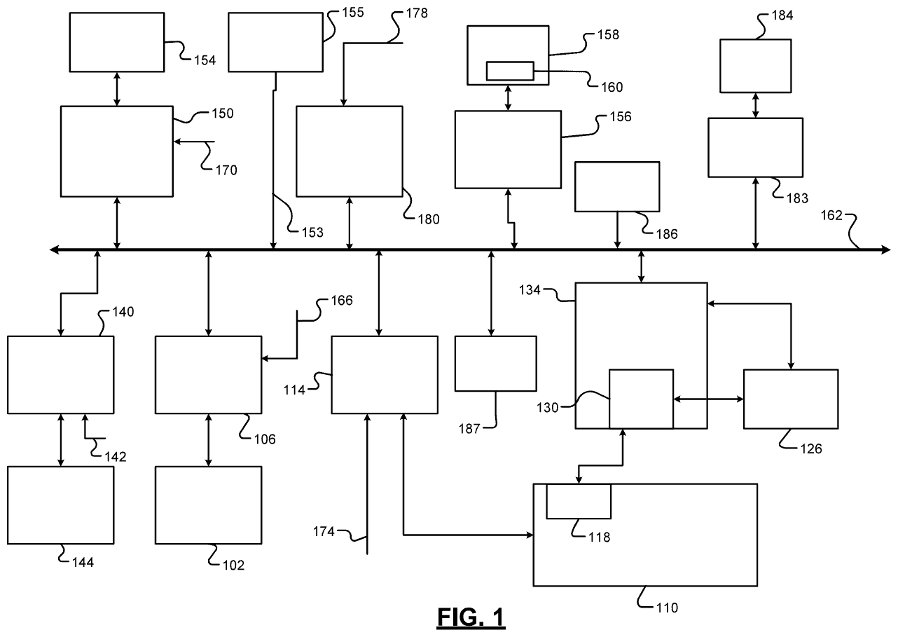

Referring now to FIG. 1, a functional block diagram of an example vehicle system is presented. While a vehicle system for a hybrid vehicle is shown and will be described, the present application is also applicable to non-hybrid vehicles, electric vehicles, fuel cell vehicles, and other types of vehicles. The present application is applicable to autonomous vehicles, semi-autonomous vehicles, non-autonomous vehicles, shared vehicles, non-shared vehicles, and other types of vehicles.

An engine 102 may combust an air/fuel mixture to generate drive torque. An engine control module (ECM) 106 controls the engine 102. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter module (PIM) 134 may control the electric motor 118 and the PCD 130. The PCD 130 applies power from the battery 126 to the electric motor 118 based on signals from the PIM 134, and the PCD 130 provides power output by the electric motor 118, for example, to the battery 126. The PIM 134 may include, for example, an inverter.

A steering control module 140 controls steering/turning of wheels of the vehicle, for example, based on driver turning of a steering wheel within the vehicle and/or steering commands from one or more vehicle control modules. A steering wheel angle (SWA) sensor (not shown) monitors rotational position of the steering wheel and generates a SWA 142 based on the position of the steering wheel. As an example, the steering control module 140 may control vehicle steering via an electronic power steering (EPS) motor 144 based on the SWA 142. However, the vehicle may include another type of steering system.

A brake control module 150 may selectively control (e.g., friction) brakes 154 of the vehicle based on one or more driver inputs, such as a brake pedal position (BPP) 170. Another driver input may be a cruise control input 153 from a cruise control module 155 when cruise control is enabled.

A damper control module 156 controls damping of dampers 158 of the wheels, respectively, of the vehicle. The dampers 158 damp vertical motion of the wheels. The damper control module 156 may control, for example, damping coefficients of the dampers 158, respectively. For example, the dampers 158 may include magnetorheological dampers, continuous damping control dampers, or another suitable type of adjustable damper. The dampers 158 include actuators 160 that adjust damping of the dampers 158, respectively. In the example of magnetorheological dampers, the actuators 160 may adjust magnetic fields applied to magnetorheological fluid within the dampers 158, respectively, to adjust damping.

Modules of the vehicle may share parameters via a network 162, such as a controller area network (CAN). A CAN may also be referred to as a car area network. For example, the network 162 may include one or more data buses. Various parameters may be made available by a given module to other modules via the network 162.

The driver inputs may include, for example, an accelerator pedal position (APP) 166 which may be provided to the ECM 106. The BPP 170 may be provided to the brake control module 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

An infotainment module 183 may output various information via one or more output devices 184. The output devices 184 may include, for example, one or more displays (non-touch screen and/or touch screen), one or more other suitable types of video output devices, one or more speakers, one or more haptic devices, and/or one or more other suitable types of output devices.

The infotainment module 183 may output video via the one or more displays. The infotainment module 183 may output audio via the one or more speakers. The infotainment module 183 may output other feedback via one or more haptic devices. For example, haptic devices may be included with one or more seats, in one or more seat belts, in the steering wheel, etc. Examples of displays may include, for example, one or more displays (e.g., on a front console) of the vehicle, a head up display (HUD) that displays information via a substrate (e.g., windshield), one or more displays that drop downwardly or extend upwardly to form panoramic views, and/or one or more other suitable displays.

The vehicle may include a plurality of external sensors and cameras, generally illustrated in FIG. 1 by 186. One or more actions may be taken based on input from the external sensors and cameras 186. For example, the infotainment module 183 may display video, various views, and/or alerts on a display via input from the external sensors and cameras 186 during driving.

As another example, brake control module 150 and/or the steering control module 140 may apply the brakes 154 and/or steer the vehicle to avoid the vehicle colliding with an object around the vehicle.

The vehicle may include one or more additional control modules that are not shown, such as a chassis control module, a battery pack control module, etc. The vehicle may omit one or more of the control modules shown and discussed.

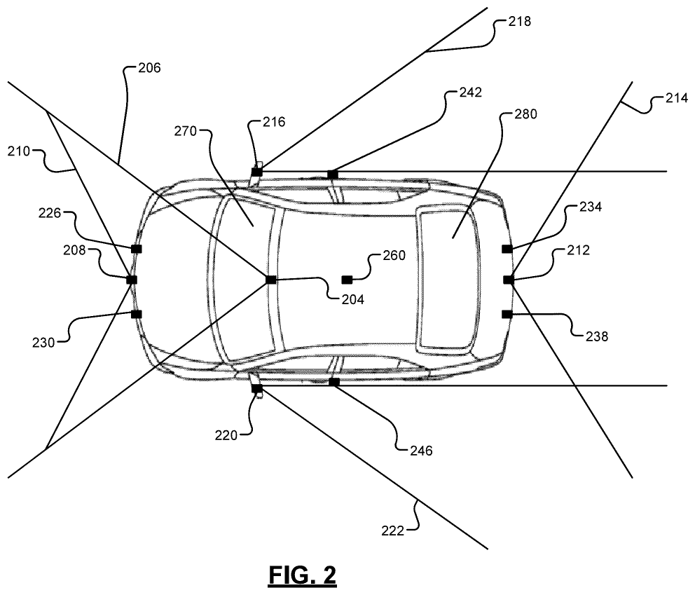

Referring now to FIG. 2, a functional block diagram of a vehicle including examples of external sensors and cameras is presented. The external sensors and cameras 186 (FIG. 1) include various cameras positioned to capture images and video outside of (external to) the vehicle and various types of sensors measuring parameters outside of (external to) the vehicle. Examples of the external sensors and cameras 186 will now be discussed. For example, a forward-facing camera 204 captures images and video of images within a predetermined field of view (FOV) 206 in front of the vehicle.

A front camera 208 may also capture images and video within a predetermined FOV 210 in front of the vehicle. The front camera 208 may capture images and video within a predetermined distance of the front of the vehicle and may be located at the front of the vehicle (e.g., in a front fascia, grille, or bumper). The forward-facing camera 204 may be located more rearward, however, such as with a rear-view mirror at a windshield of the vehicle. The forward-facing camera 204 may not be able to capture images and video of items within all of or at least a portion of the predetermined FOV of the front camera 208 and may capture images and video more than the predetermined distance of the front of the vehicle. In various implementations, only one of the forward-facing camera 204 and the front camera 208 may be included.

A rear camera 212 captures images and video within a predetermined FOV 214 behind the vehicle. The rear camera 212 may be located at the rear of the vehicle, such as near a rear license plate.

A right camera 216 captures images and video within a predetermined FOV 218 to the right of the vehicle. The right camera 216 may capture images and video within a predetermined distance to the right of the vehicle and may be located, for example, under a right side rear-view mirror. In various implementations, the right side rear-view mirror may be omitted, and the right camera 216 may be located near where the right side rear-view mirror would normally be located.

A left camera 220 captures images and video within a predetermined FOV 222 to the left of the vehicle. The left camera 220 may capture images and video within a predetermined distance to the left of the vehicle and may be located, for example, under a left side rear-view mirror. In various implementations, the left side rear-view mirror may be omitted, and the left camera 220 may be located near where the left side rear-view mirror would normally be located. While the example FOVs are shown for illustrative purposes, the present application is also applicable to other FOVs. In various implementations, FOVs may overlap, for example, for more accurate and/or inclusive stitching.

The external sensors and cameras 186 may additionally or alternatively include various other types of sensors, such as light detection and ranging (LIDAR) sensors, ultrasonic sensors, radar sensors, and/or one or more other types of sensors. For example, the vehicle may include one or more forward-facing ultrasonic sensors, such as forward-facing ultrasonic sensors 226 and 230, one or more rearward facing ultrasonic sensors, such as rearward facing ultrasonic sensors 234 and 238. The vehicle may also include one or more right side ultrasonic sensors, such as right side ultrasonic sensor 242, and one or more left side ultrasonic sensors, such as left side ultrasonic sensor 246. The vehicle may also include one or more light detection and ranging (LIDAR) sensors, such as LIDAR sensor 260. The locations of the cameras and sensors are provided as examples only and different locations could be used. Ultrasonic sensors output ultrasonic signals around the vehicle.

The external sensors and cameras 186 may additionally or alternatively include one or more other types of sensors, such as one or more sonar sensors, one or more radar sensors, and/or one or more other types of sensors.

The vehicle includes one or more windshields. In the example of FIG. 2, the vehicle includes a front windshield 270 and a rear windshield 280. In various implementations, the rear windshield 280 may be omitted.

While the example of the front windshield 270 will be discussed, the following and concepts described herein are also applicable to the rear windshield 280 and other windshields of the vehicle.

The front windshield 270 includes at least two glass panes including an inner glass pane that faces a passenger compartment and an outer glass pane that is exposed to the environment outside of the vehicle. A windshield defroster includes a transparent and electrically conductive film disposed between the glass panes of the windshield. When electrical power is applied to the film, the film functions as a resistive heater and generates heat (e.g., to defog or defrost the windshield).

In the present application, a portion of the film is electrically isolated from the remainder of the film of the defroster and serves as a portion of an antenna.

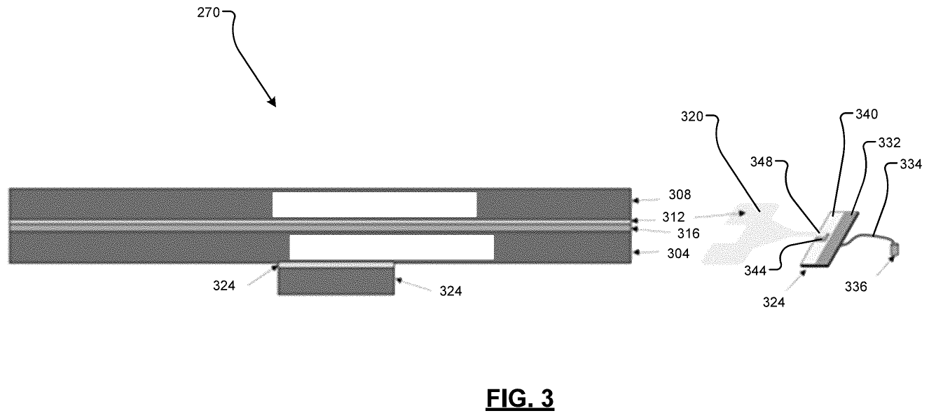

FIG. 3 includes a cross-sectional view of an example windshield and antenna and a perspective view of the antenna.

The front windshield 270 includes an inner glass pane 304 that faces the passenger cabin of the vehicle and an outer glass pane 308 that faces environment outside of the vehicle.

A transparent conductive layer 312 is disposed between the inner and outer glass panes 304 and 308. A first portion of the transparent conductive layer 312 serves as the defroster for the front windshield 270. A second portion of the transparent conductive layer 312 that is electrically isolated from the first portion is an antenna that is transparent and is disposed between the inner and outer glass panes 304 and 308. A keep out zone provides the electrical isolation of the first portion from the second portion. The transparent conductive layer 312 is removed (e.g., via ablation, cutting, etching, etc.) in the keep out zine. An example of the antenna is illustrated by 320 in FIG. 3, although the present application is applicable to other shapes of antennas. The antenna may be a slot type antenna, a monopole antenna, a bipole antenna, or another suitable type of antenna.

The transparent conductive layer 312 has a predetermined resistance per square (unitless), such as between approximately 0.5 Ohms per square and approximately 5 Ohms per square within another suitable range. Approximately may mean +/−10 percent of stated values.

A polyvinyl butyral (PVB) layer 316 may be disposed between the transparent conductive layer 312 and the inner glass pane 304. Alternatively, the PVB layer 316 may be disposed between the transparent conductive layer 312 and the outer glass pane 308. While the example of PVB is provided, another suitable material may be used. The PVB layer 316 may have a thickness, for example, of approximately 0.3 millimeters to 1.0 millimeters or another suitable thickness. Thickness may be in a direction perpendicular to the inner and outer glass panes 304 and 308.

The antenna (second portion) radiator is electromagnetically or capacitively fed by a feed assembly 324. The feed assembly 324 is adhered to the inner glass pane 304 via an adhesive 328. The feed assembly 324 includes a circuit board (e.g., a printed circuit board (PCB)) 332. The feed assembly 324 receives power via a cable 334 and a connector 336, such as a coaxial cable connector. The feed assembly 324 includes a dielectric layer 340 disposed on a portion of the circuit board 332. An electrically conductive feed 344 is disposed on the dielectric layer 340 and is electrically connected to a portion of the circuit board 332 to receive power.

The feed 344 is planar and is disposed parallel to a plane of a feed portion 348 of the antenna 320 to electromagnetically or capacitively couple the feed 344 of the feed assembly 324 to the feed portion 348 of the antenna. The feed portion 348 feeds power (e.g., radiates) to the remainder of body of the antenna 320.

In various implementations, the transparent conductive layer 312 (and therefore the antenna 320) may include silver. However, another suitable electrically conductive transparent material may be used. The antenna 320 may be a transmit and receive antenna, a receive antenna, or a transmit antenna. The antenna 320 may be used, for example, in cellular communication, WiFi communication, Bluetooth communication, or communication according to another suitable protocol. In various implementations, the antenna 320 may be used in fifth generation (5G) cellular communication (e.g., 0.617 giga hertz (GHz) to 5 GHz frequency band).

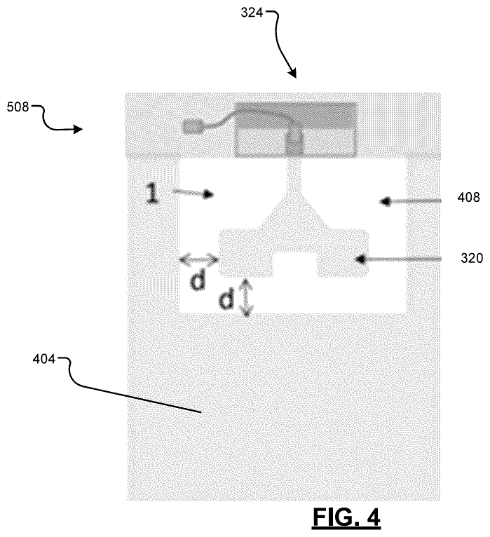

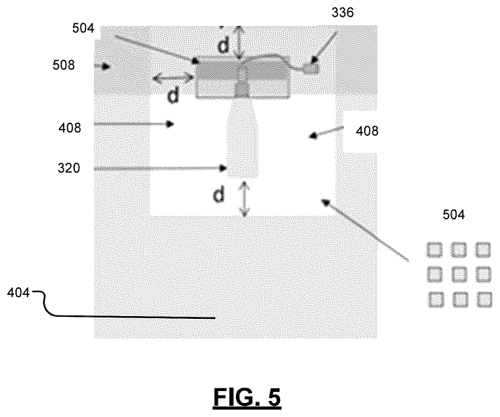

FIGS. 4 and 5 include perspective views toward example antennas 320 and illustrate defroster (first) portions 404 of the transparent conductive layer 312 and keep out zones 408. The keep out zones 408 are formed by removing portions of the transparent conductive layer 312 to electrically isolate the antenna 320 from the defroster portions 404. The keep out zones minimize electromagnetic interaction of the antenna 320 with the defroster portions 404 and minimize scattering in areas close to the antenna 320. The keep out zones set a specific boundary condition for the antenna 320 and help improve radiation off of the inner and outer glass panes 304 and 308 Since the antenna 320 is disposed between the inner and outer glass panes 304 and 308, significant fields from the antenna 320 may propagate as frequency increases. The keep out zones as described and shown herein improve radiation efficiency at frequencies greater than a predetermined frequency (e.g., approximately 3.3 GHZ). A smallest distance (d) between the antenna 320 and a closest portion of the defroster 404 may be for example at least approximately 30 mm to approximately 50 mm or another suitable value. The dimensions and shape of the keep out zone may be configured based on the operating frequency range of the antenna 320 and antenna performance (e.g., matching and radiation patterns). As shown in FIG. 5, the smallest distance (d) may also be present between the conductive layer 504 of the feed assembly 324 and the closest portion of the defroster 404.

The keep out zone may be created, for example, via ablation (e.g., laser ablation) or in another suitable manner of removing one or more portions of the transparent conductive layer 312. Other examples of removal include etching, cutting, etc. As illustrated in FIG. 5, discrete dots (e.g., square dots) 512 of the material of the transparent conductive layer 312 may be left in the keep out zone after the material removal. The inclusion of the dots in the keep out zone may minimize the visual perceivability of the antenna and the keep out zone. In other words, the inclusion of the dots in the keep out zone may make the keep out zone and the antenna less noticeable. The dots may be square, triangular, rectangular, circular, ovular, hexagonal, octagonal, or have another suitable shape. A largest linear dimension of each dot and a separation between adjacent (closest) dots may be less than or equal to approximately 3 mm to 5 mm or another suitable dimension, such as dependent on a maximum operating frequency of the antenna 320.

In various implementations, a sheet resistance of the transparent conductive layer 312 may be less than 1 ohm per square and may be 0.5+/−0.1 ohms per square. The keep out zone may partially (e.g., on 3 sides, such as in FIG. 4) or completely surround the antenna 320 (e.g., on all 4 sides, such as in FIG. 5). For example, the In various implementations, the transparent conductive layer 312 may extend into a blackout area of the windshield, which may allow the antenna 320 to be at least partially patterned under the blackout area 508 of the windshield, such as illustrated in FIG. 5. The cable 334 may be routed, for example, in a nearest A-pillar of the vehicle. This may increase ease of maintenance and/or replacement. While the example of glass inner and outer panes is provided, the present application is also applicable to other transparent dielectric substrates. The antenna 320 may be symmetrical or asymmetric.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A defrost and antenna system comprising:
a first glass pane including a first surface facing a passenger cabin of a vehicle and a second surface opposite the first surface;
a second glass pane including a third surface facing the second surface and a fourth surface facing environment outside of the vehicle; and
a keep out zone disposed between the second and third surfaces; and
transparent electrically conductive material disposed between the second and third surfaces, the transparent electrically conductive material including:
a defroster portion configured to generate heat when power is applied to the defroster portion; and
an antenna radiator that is electrically isolated from the defroster portion by the keep out zone.

2. The system of claim 1 wherein the keep out zone includes at least one portion where the transparent electrically conductive material was removed.

3. The system of claim 1 wherein discrete dots of the transparent electrically conductive material are disposed within the keep out zone.

4. The system of claim 3 wherein the dots are each square.

5. The system of claim 3 wherein a largest dimension of each of the dots is less than or equal to 5 millimeters.

6. The system of claim 3 wherein a largest dimension of each of the dots is less than or equal to 3 millimeters.

7. The system of claim 3 wherein the discrete dots are spaced apart uniformly.

8. The system of claim 7 wherein a minimum distance between adjacent ones of the dots is less than or equal to 5 millimeters.

9. The system of claim 7 wherein a minimum distance between adjacent ones of the dots is less than or equal to 3 millimeters.

10. The system of claim 3 wherein the dots are each one of circular, rectangular, ovular, triangular, hexagonal, and octagonal.

11. The system of claim 1 wherein a minimum distance between (a) a point on the antenna radiator and (b) a closest point of the defroster portion is less than or equal to 50 millimeters.

12. The system of claim 1 wherein a minimum distance between (a) a point on the antenna radiator and (b) a closest point of the defroster portion is less than or equal to 30 millimeters.

13. The system of claim 1 wherein the transparent electrically conductive material includes silver.

14. The system of claim 1 wherein the keep out zone is formed via laser ablation of the transparent electrically conductive material.

15. The system of claim 1 wherein the keep out zone extends around 3 sides of the antenna radiator.

16. The system of claim 1 wherein the keep out zone extends around all sides of the antenna radiator.

17. The system of claim 1 wherein the antenna radiator is one of a monopole antenna, a bipole antenna, and a slot antenna.

18. The system of claim 1 wherein the transparent electrically conductive material has a sheet resistance of less than or equal to 1 ohm per square unit.

19. The system of claim 1 further comprising a polyvinyl butyral layer disposed between the second and third surfaces.

20. A defrost and antenna system comprising:
a first glass pane including a first surface facing a passenger cabin of a vehicle and a second surface opposite the first surface;
a second glass pane including a third surface facing the second surface and a fourth surface facing environment outside of the vehicle; and
a keep out zone disposed between the second and third surfaces;
transparent electrically conductive material disposed between the second and third surfaces, the transparent electrically conductive material including:
a defroster portion configured to generate heat when power is applied to the defroster portion;
an antenna radiator that is electrically isolated from the defroster portion by the keep out zone;
discrete dots within the keep out zone; and
a polyvinyl butyral layer disposed between the second and third surfaces.
